(19) United States
(12) Patent Application Publication
(10) Pub. No.: US 2026/0188231 A1
(43) Pub. Date: Jul. 2, 2026

(54) DISPLAY DEVICE AND ELECTRONIC APPARATUS

(71) Applicant: Samsung Display Co., Ltd., Yongin-si (KR)

(72) Inventors: JAEKEUN LIM, Yongin-si (KR); BON-SEOG GU, Yongin-si (KR)

(21) Appl. No.: 19/430,040

(22) Filed: Dec. 22, 2025

(30) Foreign Application Priority Data
Dec. 31, 2024 (KR) 10-2024-0202554

(51) Int. Cl. G09G 3/3233

(52) U.S. Cl. CPC G09G 3/3233; G09G 2300/0819; G09G 2320/0238; G09G 2330/021

(57) ABSTRACT

A display device includes a display panel including a pixel, the pixel including a light-emitting element including an anode and a cathode, a first transistor connected between a first power line and the anode, and configured to operate according to a potential of a first node, a second transistor connected between the first node and a data line, and configured to receive a first scan signal, a third transistor connected between a second node and a reference voltage line, and configured to receive the first scan signal, a fourth transistor connected between the second node and an initialization voltage line, and configured to receive a second scan signal, and a storage capacitor connected between the first node and the second node.

### CROSS-REFERENCE TO RELATED APPLICATION

The present application claims priority to, and the benefit of, Korean Patent Application No. 10-2024-0202554, filed on Dec. 31, 2024, in the Korean Intellectual Property Office, the entire disclosure of which is incorporated herein by reference.

### BACKGROUND

Embodiments of the present disclosure described herein relate to a display device and an electronic apparatus with improved display quality.

A light-emitting display device displays an image by using a light-emitting element that generates light through the recombination of electrons and holes. The light-emitting display device has a fast response speed, and operates with low power consumption.

The light-emitting display device includes pixels connected to a data line and scan lines. In general, each of the pixels includes a light-emitting element and a pixel circuit for controlling the amount of current flowing to the light-emitting element. The pixel circuit controls the amount of current flowing through the light-emitting element in response to a data signal. In this case, light of corresponding luminance is generated to correspond to the amount of current flowing through the light-emitting diode.

### SUMMARY

Embodiments of the present disclosure provide a display device in which a circuit configuration of the display panel is simplified and the display quality is improved.

According to one or more embodiments, a display device includes a display panel including a pixel, the pixel including a light-emitting element including an anode and a cathode, a first transistor connected between a first power line and the anode, and configured to operate according to a potential of a first node, a second transistor connected between the first node and a data line, and configured to receive a first scan signal, a third transistor connected between a second node and a reference voltage line, and configured to receive the first scan signal, a fourth transistor connected between the second node and an initialization voltage line, and configured to receive a second scan signal, and a storage capacitor connected between the first node and the second node.

During a data write period, the first scan signal may be configured to have an active level, and the second scan signal may be configured to have an inactive level, wherein, during an initialization period following the data write period, the first scan signal is configured to have the inactive level, and the second scan signal is configured to have the active level.

During the data write period, the first node may be configured to receive a data voltage, and the second node may be configured to be initialized with a reference voltage from the reference voltage line.

During the initialization period, the second node may be configured to be initialized with an initialization voltage from the initialization voltage line, wherein a gate-source voltage of the first transistor during the initialization period is configured to be equal to the gate-source voltage of the first transistor during the data write period.

The cathode of the light-emitting element may be connected to a second power line configured to receive a second driving voltage, wherein the reference voltage line is configured to receive a reference voltage having a higher voltage level than that of the second driving voltage.

The initialization voltage line may be configured to receive an initialization voltage having a voltage level that is lower than or equal to that of the second driving voltage.

The pixel may further include a first emission control transistor connected between the second node and the anode, and configured to receive a first emission control signal.

The first emission control signal may be configured to have the inactive level during an inactive period, and may be configured to have the active level during an active period, wherein the inactive period overlaps the data write period, and wherein the initialization period includes a first initialization period overlapping the inactive period, and a second initialization period overlapping the active period.

During the data write period, the first node may be configured to receive a data voltage, and the second node may be configured to be initialized with a reference voltage from the reference voltage line.

During the initialization period, the second node may be configured to be initialized with an initialization voltage from the initialization voltage line, wherein a gate-source voltage of the first transistor during the initialization period is configured to be equal to the gate-source voltage of the first transistor during the data write period.

The pixel may further include a second emission control transistor connected between the first power line and the first transistor, and configured to receive a second emission control signal, and a hold capacitor connected between the second node and the first power line.

The display panel may be configured to display an image during driving frames including a write frame and at least one holding frame, wherein the write frame includes the data write period and the initialization period, and wherein the holding frame does not include the data write period, and includes the initialization period.

The first transistor, the second transistor, the third transistor, and the fourth transistor may include an oxide semiconductor.

According to one or more embodiments, a display device includes a display panel including a pixel, the pixel including a light-emitting element including an anode and a cathode, a first transistor connected between a first power line and the anode, and configured to operate according to a potential of a first node, a second transistor connected between the first node and a data line, and configured to receive a first scan signal, a third transistor connected between a second node and a reference voltage line, and configured to receive the first scan signal, an emission control transistor connected between the second node and the anode, and configured to receive an emission control signal, a fourth transistor connected between the anode and an initialization voltage line, and configured to receive a second scan signal, and a storage capacitor connected between the first node and the second node.

During a data write period, the first scan signal may be configured to have an active level, and the second scan signal may be configured to have an inactive level, wherein, during an initialization period following the data write period, the first scan signal is configured to have the inactive level, and the second scan signal is configured to have the active level.

The emission control signal may be configured to have the inactive level during an inactive period, and may be configured to have the active level during an active period, wherein the inactive period overlaps the data write period and does not overlap the initialization period.

During the data write period, the first node may be configured to receive a data voltage, and the second node may be configured to be initialized with a reference voltage from the reference voltage line.

During the initialization period, the second node may be configured to be initialized with an initialization voltage from the initialization voltage line, wherein a gate-source voltage of the first transistor during the initialization period is configured to be equal to the gate-source voltage of the first transistor during the data write period.

The display panel may be configured to display an image during driving frames including a write frame and at least one holding frame, wherein the write frame includes the data write period and the initialization period, and wherein the holding frame does not include the data write period, and includes the initialization period.

According to one or more embodiments, an electronic apparatus includes a display module including a pixel, and a processor configured to drive the display module, wherein the pixel includes a light-emitting element including an anode and a cathode, a first transistor connected between a first power line and the anode, and configured to operate according to a potential of a first node, a second transistor connected between the first node and a data line, and configured to receive a first scan signal, a third transistor connected between a second node and a reference voltage line, and configured to receive the first scan signal, a fourth transistor connected between the second node and an initialization voltage line, and configured to receive a second scan signal, and a storage capacitor connected between the first node and the second node.

### BRIEF DESCRIPTION OF THE DRAWINGS

The above and other aspects of the present disclosure will become apparent by describing in detail embodiments thereof with reference to the accompanying drawings.

FIG. 1 is a block diagram of a display device, according to one or more embodiments of the present disclosure.

FIG. 2 is a circuit diagram of a pixel, according to one or more embodiments of the present disclosure.

FIGS. 3A and 3B are drawings for describing an operation of a pixel during a data write period, according to one or more embodiments of the present disclosure.

FIGS. 4A and 4B are drawings for describing an operation of a pixel during an initialization period, according to one or more embodiments of the present disclosure.

FIGS. 5A and 5B are drawings for describing an operation of a pixel during an emission period, according to one or more embodiments of the present disclosure.

FIG. 6 is a waveform diagram showing an i-th write scan signal and an i-th initialization scan signal in a variable frequency mode, according to one or more embodiments of the present disclosure.

FIG. 7 is a block diagram of a display device, according to one or more embodiments of the present disclosure.

FIG. 8 is a circuit diagram of a pixel, according to one or more embodiments of the present disclosure.

FIGS. 9A and 9B are drawings for describing an operation of a pixel during a data write period, according to one or more embodiments of the present disclosure.

FIGS. 10A and 10B are drawings for describing an operation of a pixel during an initialization period, according to one or more embodiments of the present disclosure.

FIGS. 11A and 11B are drawings for describing an operation of a pixel during an emission period, according to one or more embodiments of the present disclosure.

FIG. 12 is a waveform diagram showing an i-th write scan signal, an i-th initialization scan signal, and an i-th emission control signal in a variable frequency mode, according to one or more embodiments of the present disclosure.

FIG. 13 is a circuit diagram of a pixel, according to one or more embodiments of the present disclosure.

FIGS. 14A and 14B are drawings for describing an operation of a pixel during a data write period, according to one or more embodiments of the present disclosure.

FIGS. 15A and 15B are drawings for describing an operation of a pixel during an initialization period, according to one or more embodiments of the present disclosure.

FIGS. 16A and 16B are drawings for describing an operation of a pixel during an emission period, according to one or more embodiments of the present disclosure.

FIG. 17 is a circuit diagram of a pixel, according to one or more embodiments of the present disclosure.

FIG. 18 is a block diagram of an electronic apparatus, according to one or more embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer, or section described below could be termed a second element, component, region, layer, or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same.” In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

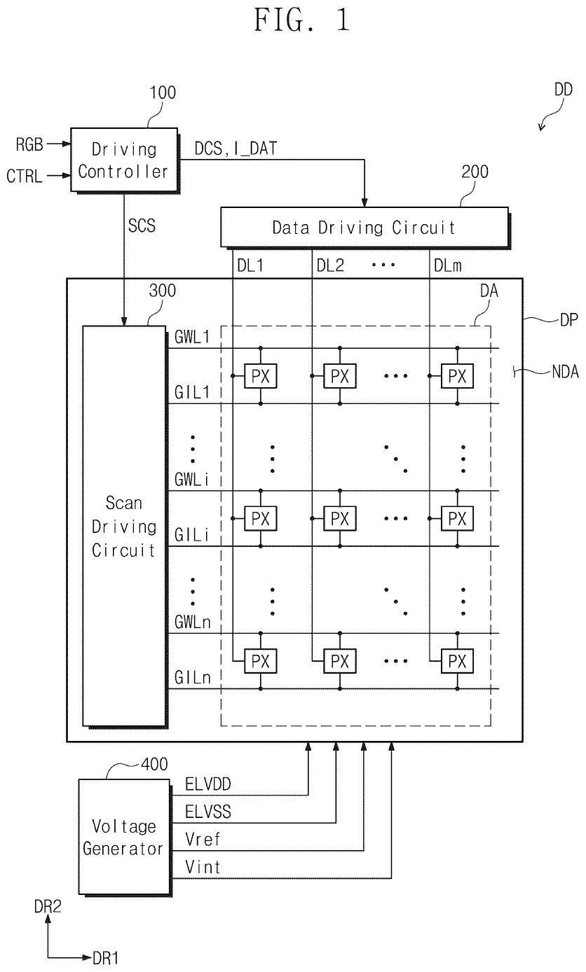

FIG. 1 is a block diagram of a display device DD, according to one or more embodiments of the present disclosure.

Referring to FIG. 1, the display device DD may include a display panel DP, a driving controller 100, and a panel driver. According to one or more embodiments of the present disclosure, the panel driver may include a data-driving circuit 200 (or a data driver), a scan-driving circuit 300 (or a scan driver), and a voltage generator 400.

The display panel DP may include a display area DA and a non-display area NDA surrounding at least part of the display area DA (e.g., surrounding in plan view). The display panel DP may include a plurality of pixels PX placed in the display area DA. The display panel DP may include data lines DL1 to DLm, write scan lines GWL1 to GWLn, and initialization scan lines GIL1 to GILn. The data lines DL1 to DLm may be arranged in a first direction DR1, and each of the data lines DL1 to DLm may extend in a second direction DR2. The write scan lines GWL1 to GWLn and the initialization scan lines GIL1 to GILn may extend in the first direction DR1 and be arranged in the second direction DR2. The write scan lines GWL1 to GWLn may be referred to as “first scan lines,” and the initialization scan lines GIL1 to GILn may be referred to as “second scan lines.”

The driving controller 100 receives an image signal RGB and a control signal CTRL. The driving controller 100 generates image data I_DAT by converting a data format of the image signal RGB so as to be suitable for the interface specification of the data-driving circuit 200. The driving controller 100 may generate a first control signal DCS and a second control signal SCS based on the control signal CTRL.

The data-driving circuit 200 receives the first control signal DCS and the image data I_DAT from the driving controller 100. The data-driving circuit 200 converts the image data I_DAT into data signals and then outputs the data signals to data lines DL1 to DLm. The data signals refer to analog voltages corresponding to grayscale values of the image data I_DAT.

The scan-driving circuit 300 may be located in the non-display area NDA of the display panel DP. The scan-driving circuit 300 receives the second control signal SCS from the driving controller 100 and outputs scan signals in response to the second control signal SCS. The scan-driving circuit 300 may output write scan signals to the write scan lines GWL1 to GWLn and may output initialization scan signals to the initialization scan lines GIL1 to GILn. The write scan signals may be referred to as “first scan signals,” and the initialization scan signals may be referred to as “second scan signals.”

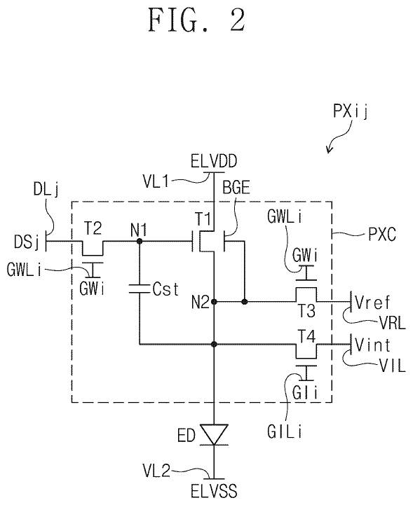

Each of the plurality of pixels PX according to one or more embodiments of the present disclosure includes a light-emitting element ED (see FIG. 2) and a pixel circuit PXC (see FIG. 2”) that controls light emission of the light-emitting element ED. The pixel circuit PXC may include at least one or more transistors and at least one or more capacitors. The pixel circuit PXC may be referred to as a “pixel circuit unit.”

The voltage generator 400 (or a power supply unit) generates voltages suitable to operate the display panel DP. In one or more embodiments of the present disclosure, the voltage generator 400 may generate a first driving voltage ELVDD, a second driving voltage ELVSS, a reference voltage Vref, and an initialization voltage Vint.

FIG. 2 is a circuit diagram of a pixel PXij, according to one or more embodiments of the present disclosure.

FIG. 2 illustrates one pixel PXij among the pixels PX illustrated in FIG. 1. Because the pixels PX have the same circuit structure, descriptions of the remaining pixels PX is omitted by describing the configuration of one pixel PXij in FIG. 2.

Referring to FIG. 2, the pixel PXij is connected to an i-th write scan line GWLi among the write scan lines GWL1 to GWLn (see FIG. 1), an i-th initialization scan line GILi among the initialization scan lines GIL1 to GILn (see FIG. 1), and a j-th data line DLj among the plurality of data lines DL1 to DLm (see FIG. 1).

The pixel PXij may include the pixel circuit PXC (or a pixel circuit unit) and the light-emitting element ED electrically connected to the pixel circuit PXC. In one or more embodiments, the pixel circuit PXC may include four transistors (referred to as first to fourth transistors T1 to T4) and one capacitor (hereinafter, referred to as a “storage capacitor Cst”). In one or more embodiments of the present disclosure, one of the four transistors of the pixel circuit PXC may be omitted, or an additional transistor may be further included in the pixel circuit PXC.

The i-th write scan line GWLi may supply an i-th write scan signal GWi to the pixel PXij, and the i-th initialization scan line GILi may supply an i-th initialization scan signal GIi to the pixel PXij. The j-th data line DLj may supply a j-th data signal DSj to the pixel PXij. The j-th data signal DSj may have a voltage level corresponding to a grayscale value of the image data I_DAT (see FIG. 1) output from the driving controller 100 (see FIG. 1).

Moreover, the pixel PXij may be connected to a first power line VL1 receiving the first driving voltage ELVDD, a second power line VL2 receiving the second driving voltage ELVSS, a reference voltage line VRL receiving the reference voltage Vref, and an initialization voltage line VIL receiving the initialization voltage Vint. The first driving voltage ELVDD may have a higher voltage level than the second driving voltage ELVSS. The reference voltage Vref may have a lower voltage level than the first driving voltage ELVDD, and may have a higher voltage level than the second driving voltage ELVSS. The initialization voltage Vint may have a voltage level that is lower than or equal to the second driving voltage ELVSS.

In one or more embodiments, each of the first to fourth transistors T1 to T4 may be an N-type transistor. Each of the first to fourth transistors T1 to T4 may include an oxide semiconductor as a semiconductor layer.

The light-emitting element ED may include an anode and a cathode. When the light-emitting element ED is an organic light-emitting element, the light-emitting element ED may further include an organic layer located between an anode and a cathode. The cathode of the light-emitting element ED may be connected to the second power line VL2. In one or more embodiments, the cathode of the light-emitting element ED may be directly connected to the second power line VL2. The anode of the light-emitting element ED may be connected to the pixel circuit PXC. The light-emitting element ED may emit light so as to correspond to the amount of current flowing in the first transistor T1 of the pixel circuit PXC.

The first transistor T1 is connected between the first power line VL1 for receiving the first driving voltage ELVDD, and the anode of the light-emitting element ED. The first transistor T1 may be referred to as a “driving transistor.” The first transistor T1 may include a first electrode, a second electrode, and a gate electrode. The gate electrode of the first transistor T1 may be connected to a first node N1, the first electrode of the first transistor T1 may be connected to the first power line VL1 receiving the first driving voltage ELVDD, and the second electrode of the first transistor T1 may be connected to a second node N2. The first electrode may be referred to as the drain of the first transistor T1, and the second electrode may be referred to as the source of the first transistor T1. The first transistor T1 may operate depending on (e.g., based on, or according to) the potential of the first node N1. In one or more embodiments, the first transistor T1 may further include a back gate electrode BGE. The back gate electrode BGE may face the gate electrode of the first transistor T1, and may be connected to the second electrode of the first transistor T1.

The second transistor T2 is connected between the j-th data line DLj and the first node N1, and receives the i-th write scan signal GWi (e.g., the first scan signal). The second transistor T2 may be referred to as a “switching transistor.” The second transistor T2 may include a first electrode connected to the j-th data line DLj, a second electrode connected to the first node N1, and a gate electrode connected to the i-th write scan line GWLi. The second transistor T2 may transmit the j-th data signal DSj received through the j-th data line DLj to the first node N1 in response to the i-th write scan signal GWi received through the i-th write scan line GWLi.

The storage capacitor Cst may be connected between the first node N1 and the second node N2. The storage capacitor Cst may include a first electrode connected to the first node N1, and a second electrode connected to the second node N2. The storage capacitor Cst may store difference voltage between the first node N1 and the second node N2.

The first node N1 may be defined as a node to which the gate electrode of the first transistor T1, the second electrode of the second transistor T2, and the first electrode of the storage capacitor Cst are connected.

The third transistor T3 is connected between the reference voltage line VRL and the second node N2, and receives the i-th write scan signal GWi. The third transistor T3 may include a first electrode connected to the reference voltage line VRL, a second electrode connected to the second node N2, and a gate electrode connected to the i-th write scan line GWLi. The third transistor T3 may be turned on in response to the i-th write scan signal GWi received through the i-th write scan line GWLi to transmit the reference voltage Vref to the second node N2.

The fourth transistor T4 is connected between the initialization voltage line VIL and the second node N2, and receives the i-th initialization scan signal GIi. The fourth transistor T4 may include a first electrode connected to the initialization voltage line VIL, a second electrode connected to the second node N2, and a gate electrode connected to the i-th initialization scan line GILi. The fourth transistor T4 may be turned on in response to the i-th initialization scan signal GIi received through the i-th initialization scan line GILi to transmit the initialization voltage Vint to the second node N2.

The second node N2 may be defined as a node to which the second electrode of the first transistor T1, the second electrode of the storage capacitor Cst, the second electrode of the third transistor T3, and the second electrode of the fourth transistor T4 are connected.

In one or more embodiments, the second and third transistors T2 and T3 may receive the same scan signal (e.g., the i-th write scan signal GWi). Accordingly, the number of scan signals suitable to drive the pixel PXij may be reduced to 2, and thus the number of driving circuits suitable to drive the pixel PXij may be reduced to 2. When the number of scan driving circuits is reduced, the width of the non-display area NDA (see FIG. 1) of the display panel DP (see FIG. 1) may be reduced, and thus an increase in the dead space of the display panel DP may be reduced or prevented.

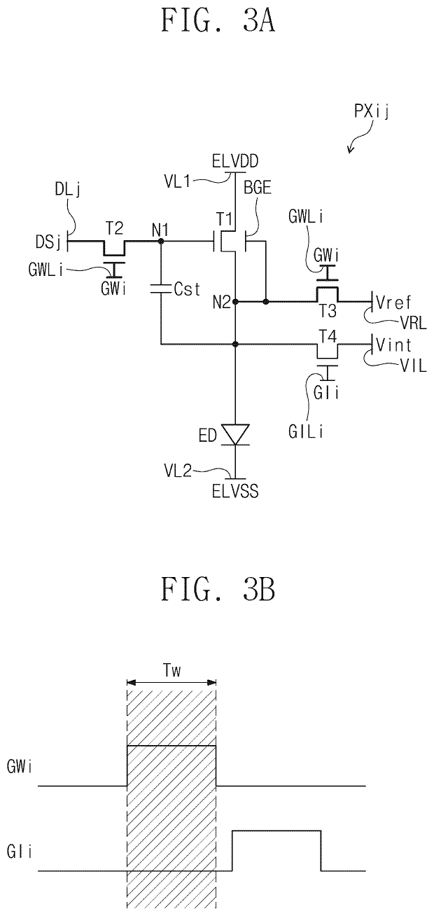

FIGS. 3A and 3B are drawings for describing an operation of the pixel PXij during a data write period Tw, according to one or more embodiments of the present disclosure.

Referring to FIGS. 3A and 3B, the i-th write scan signal GWi may have an active level (e.g., a high level) during the data write period Tw, and the i-th initialization scan signal GIi may have an inactive level (e.g., a low level) during the data write period Tw.

During the data write period Tw, the second transistor T2 and the third transistor T3 are turned on in response to the i-th write scan signal GWi, and the fourth transistor T4 is turned off in response to the i-th initialization scan signal GIi. Accordingly, during the data write period Tw, the j-th data signal DSj supplied from the j-th data line DLj is applied (or written) to the first node N1 through the second transistor T2 that is turned on. In this case, the first node N1 may have a voltage level corresponding to the j-th data signal DSj (e.g., referred to as “data voltage Vd”). Furthermore, during the data write period Tw, the second node N2 is initialized to the reference voltage Vref through the third transistor T3 that is turned on. As an example of the present disclosure, the reference voltage Vref may have a higher voltage level than the second driving voltage ELVSS.

Accordingly, during the data write period Tw, gate-source voltage Vgs of the first transistor T1 may be “Vd−Vref.”

The data write period Tw may be terminated (e.g., may end) at a point in time when the i-th write scan signal GWi is inactive.

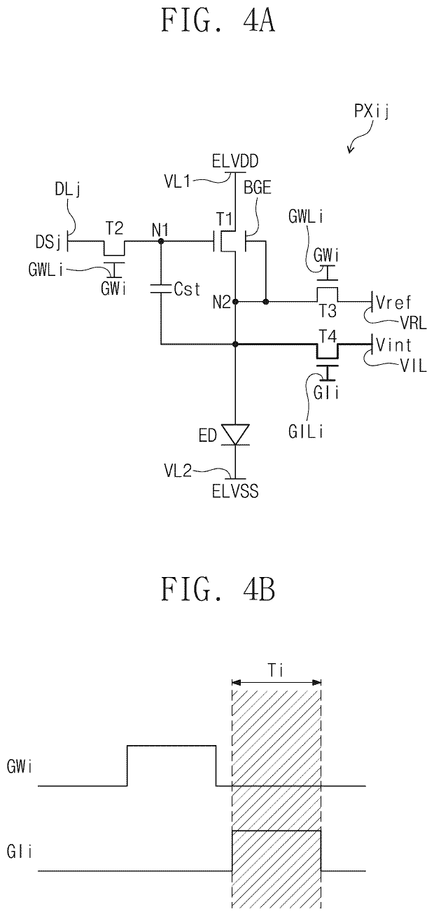

FIGS. 4A and 4B are drawings for describing an operation of the pixel PXij during an initialization period Ti, according to one or more embodiments of the present disclosure.

Referring to FIGS. 4A and 4B, when the data write period Tw (see FIG. 3B) is terminated, the initialization period Ti occurs. That is, the data write period Tw precedes the initialization period Ti.

During the initialization period Ti, the i-th initialization scan signal GIi may have an active level (e.g., a high level), and the i-th write scan signal GWi may have an inactive level (e.g., a low level).

During the initialization period Ti, the fourth transistor T4 may be turned on in response to the i-th initialization scan signal GIi, and the second and third transistors T2 and T3 may be turned off in response to the i-th write scan signal GWi. Accordingly, the initialization voltage Vint is applied to the second node N2 during the initialization period Ti. When the potential “Vs” of the second node N2 changes to the initialization voltage Vint, a change amount “ΔV” of the second node N2 may be “Vref−Vint.” As an example of the present disclosure, the initialization voltage Vint may have a voltage level that is lower than or equal to the second driving voltage ELVSS.

Here, the first node N1 is coupled to the second node N2 by the storage capacitor Cst, and thus the potential “Vg” of the first node N1 may change depending on a change amount “ΔV=Vref−Vint” of the second node N2. That is, during the initialization period Ti, the potential “Vg” of the first node N1 changes to “Vd−Vref+Vint.” Accordingly, during the initialization period Ti, the gate-source voltage “Vgs” of the first transistor T1 may be “(Vd−Vref+Vint)−Vint=Vd−Vref.” That is, even though the data write period Tw is changed to the initialization period Ti, and thus the potential “Vs” of the second node N2 is changed, the gate-source voltage “Vgs” of the first transistor T1 may be maintained as “Vd−Vref.”

Moreover, regardless of the voltage level of the initialization voltage Vint, the gate-source voltage “Vgs” of the first transistor T1 may be maintained as “Vd−Vref.” That is, a gate-source voltage Vgs of the first transistor T1 during the data write period Tw may be the same as the gate-source voltage “Vgs” of the first transistor T1 during the initialization period Ti.

As an example of the present disclosure, in a situation where the reference voltage Vref is about 3 V and the initialization voltage Vint is about 0 V, when the j-th data signal DSj is a signal for expressing black gradation, the data voltage “Vd” may be about 0 V. That is, even though the data voltage “Vd” of about 0 V is applied to the gate electrode of the first transistor T1 to express the black gradation, the gate-source voltage “Vgs” of the first transistor T1 as “Vd−Vref=−3 V” may be lower than the data voltage “Vd” of about 0 V. Accordingly, when the black gradation is expressed, the gate-source voltage “Vgs” of the first transistor T1 may be lower than about 0 V voltage, and thus the first transistor T1 may be completely maintained in a turn-off state. As a result, it is possible to reduce or prevent the likelihood of a problem of not accurately expressing the black gradation otherwise occurring due to current leaks through the first transistor T1 even when data voltage for expressing the black gradation does not have negative voltage.

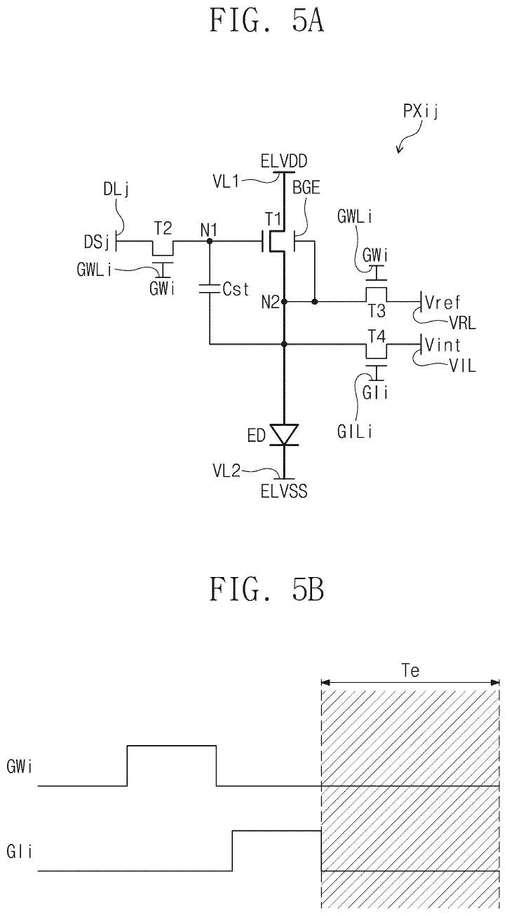

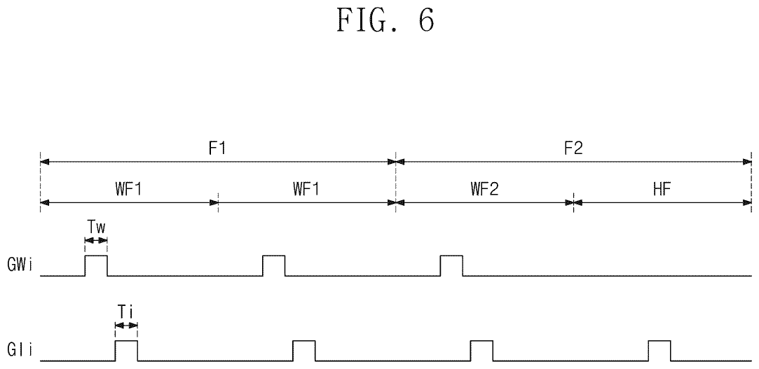

FIGS. 5A and 5B are drawings for describing an operation of the pixel PXij during an emission period Te, according to one or more embodiments of the present disclosure.

Referring to FIGS. 5A and 5B, when the initialization period Ti (see FIG. 4B) is terminated, the emission period Te may occur.

When the j-th data signal DSj is a signal for expressing white gradation, the data voltage “Vd” may have a voltage level that is higher than the reference voltage Vref. In this case, the gate-source voltage “Vgs” of the first transistor T1 may be greater than a threshold voltage “Vth.” Accordingly, when the gate-source voltage “Vgs” of the first transistor T1 is greater than the threshold voltage “Vth,” the first transistor T1 may be turned on, and driving current may flow between the first power line VL1 and the second power line VL2 through the first transistor T1 turned on. The luminance of the light output through the light-emitting element ED may vary depending on the magnitude of the driving current.

When the j-th data signal DSj is a signal for expressing black gradation, the data voltage “Vd” may have a voltage level that is lower than the reference voltage Vref. In this case, the gate-source voltage “Vgs” of the first transistor T1 may be smaller than the threshold voltage Vth. Accordingly, the first transistor T1 may be turned off, and the driving current may not be applied to the light-emitting element ED. In this case, the light-emitting element ED is turned off to express the black gradation.

Even though the data voltage “Vd” or the initialization voltage Vint having black gradation is not set to a voltage lower than about 0 V when the gate-source voltage “Vgs” of the first transistor T1 has “Vd−Vref,” the light-emitting element ED may stably express the black gradation.

FIG. 6 is a waveform diagram showing an i-th write scan signal and an i-th initialization scan signal in a variable frequency mode, according to one or more embodiments of the present disclosure.

Referring to FIGS. 1 and 6, the driving controller 100 according to one or more embodiments of the present disclosure may determine an operating frequency, and may control operations of the data-driving circuit 200 and the scan-driving circuit 300 depending on the determined operating frequency.

The operating frequency of the display device DD may be changed in various manners. In one or more embodiments of the present disclosure, a first operating frequency may be the highest operating frequency at which the display device DD is capable of operating. For example, the first operating frequency may be 360 Hz. The first operating frequency may be referred to as a “reference frequency” or “maximum frequency.”

When the display device DD operates at the first operating frequency, the display device DD may display an image during a first driving frame F1. The first driving frame F1 may include a first write frame WF1. When the display device DD operates at a second operating frequency, the display device DD may display an image during a second driving frame F2. When the second operating frequency is lower than the first operating frequency, the second driving frame F2 may include a second write frame WF2 and at least one holding frame HF. The second write frame WF2 may have the same duration as the first write frame WF1. The number of holding frames HF may vary depending on the magnitude of the second operating frequency.

The i-th write scan signal GWi (e.g., “first scan signal”) and the i-th initialization scan signal GIi (e.g., “second scan signal”) may be activated during the first and second write frames WF1 and WF2. The i-th write scan signal GWi may be deactivated during the holding frame HF. The i-th initialization scan signal GIi may be activated during the holding frame HF. Accordingly, the holding frame HF may not include the data write period Tw, but may include the initialization period Ti. During the initialization period Ti of the holding frame HF, the second node N2 (see FIG. 2) of the pixel PX may be initialized with the initialization voltage Vint. Even when the potential “Vs” of the second node N2 changes to the initialization voltage Vint during the initialization period Ti of the holding frame HF, the gate-source voltage “Vgs” of the first transistor T1 (see FIG. 2) may be maintained as “Vd−Vref.”

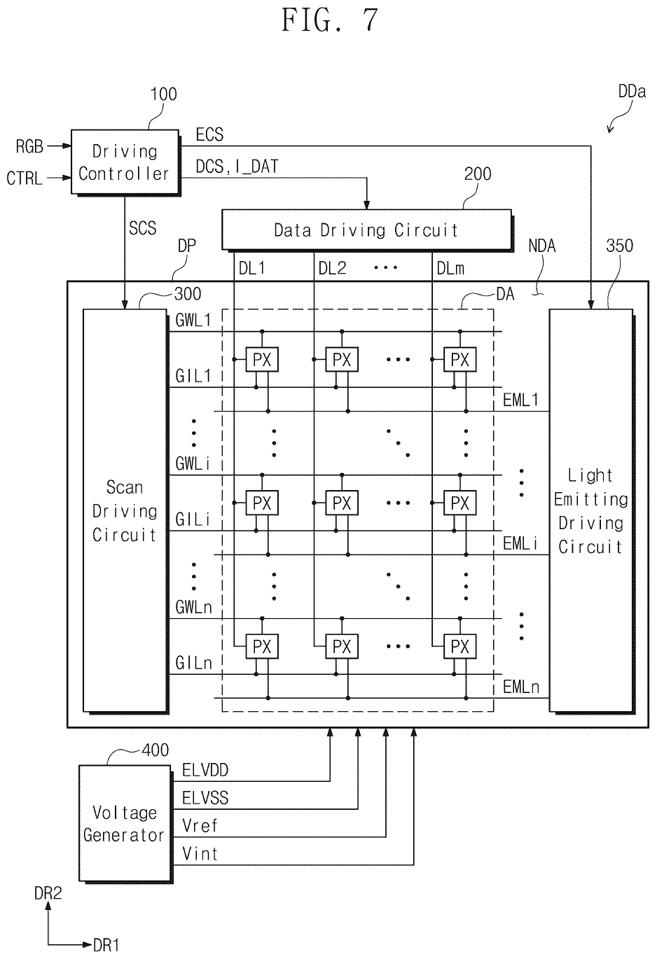

FIG. 7 is a block diagram of a display device, according to one or more embodiments of the present disclosure. However, the same reference numerals are given to the same components as those shown in FIG. 1 among the components shown in FIG. 7, and thus a detailed description thereof will be omitted.

Referring to FIG. 7, the display device DDa may include the display panel DP, the driving controller 100, and a panel driver. As an example of the present disclosure, the panel driver may include the data-driving circuit 200, the scan-driving circuit 300, a light-emitting-driving circuit 350 (or a light-emitting driver), and the voltage generator 400.

The display panel DP may include the display area DA, and the non-display area NDA surrounding at least part of the display area DA (e.g. surrounding in plan view). The display panel DP may include the plurality of pixels PX placed in the display area DA. The display panel DP may include the write scan lines GWL1 to GWLn, the initialization scan lines GIL1 to GILn, and emission control lines EML1 to EMLn.

The driving controller 100 may generate the first control signal DCS, the second control signal SCS, and a third control signal ECS based on the control signal CTRL.

The light-emitting-driving circuit 350 may be placed in the non-display area NDA of the display panel DP. As an example of the present disclosure, the scan-driving circuit 300 may be positioned adjacent to a first side (e.g., left) of the display area DA, and the light-emitting-driving circuit 350 may be positioned adjacent to a second side (e.g., right) of the display area DA, which is different from the first side. As an example of the present disclosure, the second side may be opposite to the first side. In the example shown in FIG. 7, the scan-driving circuit 300 and the light-emitting-driving circuit 350 are respectively positioned on opposite sides of the display area DA, but the present disclosure is not limited thereto. For example, the scan-driving circuit 300 and the light-emitting-driving circuit 350 may be positioned adjacent to each other on one of the first side and the second side of the display panel DP. In one or more embodiments, the scan-driving circuit 300 and the light-emitting-driving circuit 350 may be integrated into one circuit.

The light-emitting-driving circuit 350 receives the third control signal ECS from the driving controller 100, and outputs emission control signals to the emission control lines EML1 to EMLn in response to the third control signal ECS.

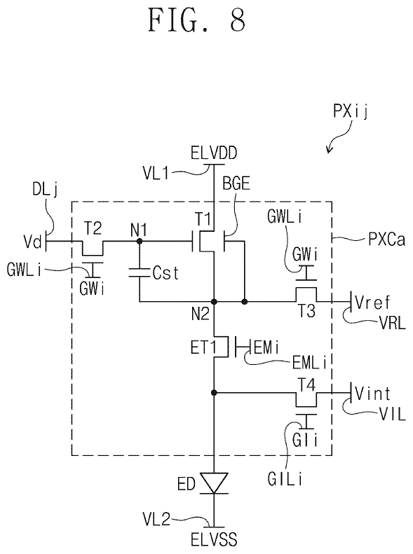

FIG. 8 is a circuit diagram of a pixel, according to one or more embodiments of the present disclosure.

Referring to FIG. 8, the pixel PXij is connected to the i-th write scan line GWLi among the write scan lines GWL1 to GWLn (see FIG. 7), the i-th initialization scan line GILi among the initialization scan lines GIL1 to GILn (see FIG. 7), and the j-th data line DLj among the plurality of data lines DL1 to DLm (see FIG. 7). The pixel PXij is further connected to an i-th emission control line EMLi among the emission control lines EML1 to EMLn (see FIG. 7).

The pixel PXij may include a pixel circuit PXCa (or a pixel circuit unit) and the light-emitting element ED electrically connected to the pixel circuit PXCa. In one or more embodiments, the pixel circuit PXCa may include five transistors (referred to as first to fourth transistors T1 to T4 and a first emission control transistor ET1) and one capacitor (hereinafter, referred to as a “storage capacitor Cst”). In one or more embodiments of the present disclosure, one of the five transistors of the pixel circuit PXCa may be omitted, or an additional transistor may be further included in the pixel circuit PXCa.

In one or more embodiments, each of the first to fourth transistors T1 to T4 and the first emission control transistor ET1 may be an N-type transistor. Each of the first to fourth transistors T1 to T4 and the first emission control transistor ET1 may include an oxide semiconductor as a semiconductor layer.

The first to third transistors T1 to T3 and the storage capacitor Cst are the same as the configuration shown in FIG. 2, and thus a detailed description is omitted.

The first emission control transistor ET1 is connected between the second node N2 and the light-emitting element ED to receive an i-th emission control signal EMi (e.g., a “first emission control signal”). The first emission control transistor ET1 may include a first electrode connected to the second node N2, a second electrode connected to the anode of the light-emitting element ED, and a gate electrode connected to the i-th emission control line EMLi. The first emission control transistor ET1 electrically connects or disconnects the second node N2 to or from the anode in response to the i-th emission control signal EMi received through the i-th emission control line EMLi.

The second node N2 may be defined as a node to which the second electrode of the first transistor T1, the second electrode of the storage capacitor Cst, the second electrode of the third transistor T3, and the first electrode of the first emission control transistor ET1 are connected.

The fourth transistor T4 is connected between the initialization voltage line VIL and the anode of the light-emitting element ED to receive the i-th initialization scan signal GIi. The fourth transistor T4 may include a first electrode connected to the initialization voltage line VIL, a second electrode connected to the anode of the light-emitting element ED, and a gate electrode connected to the i-th initialization scan line GILi. The fourth transistor T4 may be turned on in response to the i-th initialization scan signal GIi received through the i-th initialization scan line GILi to deliver the initialization voltage Vint to the anode of the light-emitting element ED.

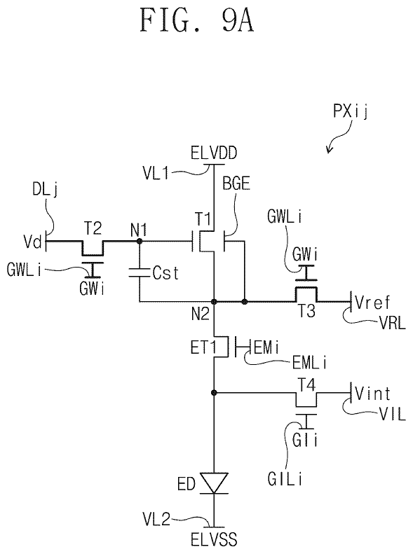

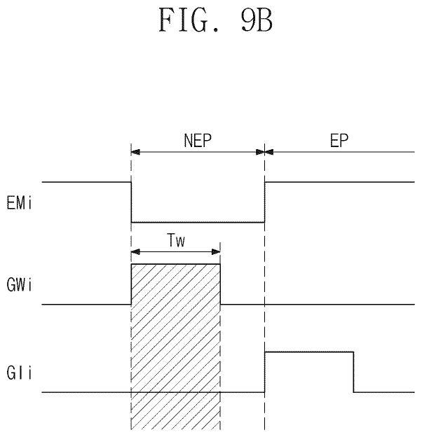

FIGS. 9A and 9B are drawings for describing an operation of a pixel during the data write period Tw, according to one or more embodiments of the present disclosure.

Referring to FIGS. 9A and 9B, the i-th emission control signal EMi has an inactive level during an inactive period NEP, and has an active level during an active period EP. The i-th write scan signal GWi may have an active level (e.g., a high level) during the data write period Tw, and the i-th initialization scan signal GIi may have an inactive level (e.g., a low level) during the data write period Tw. As an example of the present disclosure, the inactive period NEP of the i-th emission control signal EMi may overlap the data write period Tw.

During the data write period Tw, the second transistor T2 and the third transistor T3 are turned on in response to the i-th write scan signal GWi, and the fourth transistor T4 is turned off in response to the i-th initialization scan signal GIi. Accordingly, during the data write period Tw, the j-th data signal DSj supplied from the j-th data line DLj is applied (or written) to the first node N1 through the second transistor T2 that is turned on. In this case, the first node N1 may have a voltage level corresponding to the j-th data signal DSj (e.g., referred to as “data voltage Vd”). Furthermore, during the data write period Tw, the second node N2 is initialized to the reference voltage Vref through the third transistor T3 that is turned on.

During the inactive period NEP, the first emission control transistor ET1 is turned off in response to the i-th emission control signal EMi. Accordingly, during the inactive period NEP, the second node N2 may be electrically separated from, or electrically disconnected from, the anode of the light-emitting element ED. That is, during the data write period Tw, when the second node N2 is initialized to the reference voltage Vref, the anode of the light-emitting element ED is not initialized.

During the data write period Tw, gate-source voltage “Vgs” of the first transistor T1 may be “Vd−Vref.”

The data write period Tw may be terminated at a point in time when the i-th write scan signal GWi is inactive.

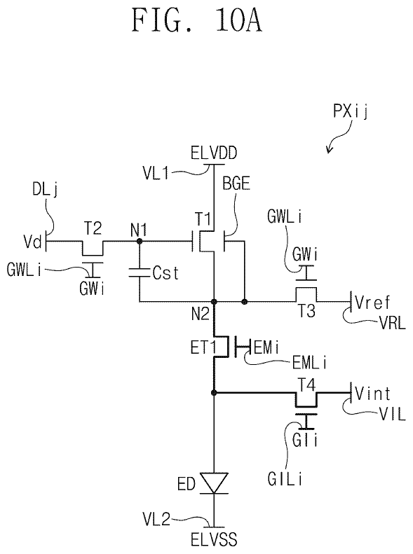

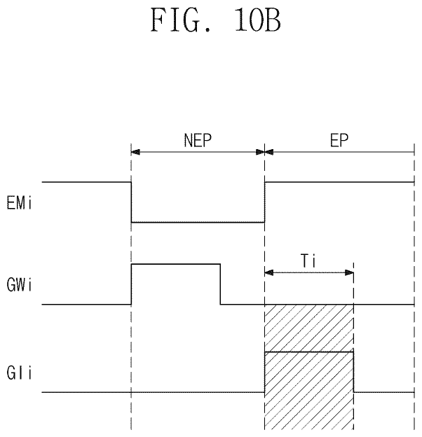

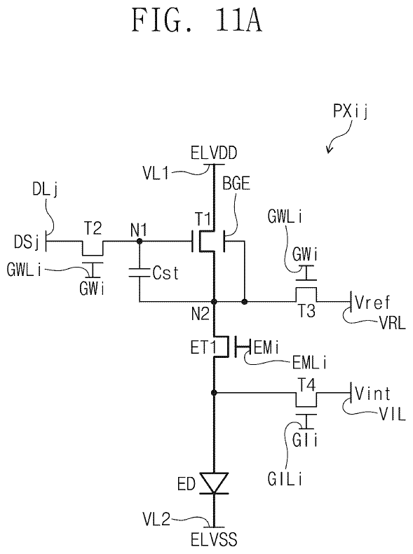

FIGS. 10A and 10B are drawings for describing an operation of a pixel during an initialization period, according to one or more embodiments of the present disclosure.

Referring to FIGS. 10A and 10B, when the data write period Tw (see FIG. 9B) is terminated, the initialization period Ti occurs. That is, the data write period Tw precedes the initialization period Ti (e.g., the initialization period Ti follows the data write period Tw). The active period EP of the i-th emission control signal EMi may be initiated at a point in time when the initialization period Ti is initiated. Accordingly, the initialization period Ti may not overlap the inactive period NEP of the i-th emission control signal EMi, and may overlap the active period EP of the i-th emission control signal EMi.

During the initialization period Ti, the fourth transistor T4 may be turned on in response to the i-th initialization scan signal GIi, and the second and third transistors T2 and T3 may be turned off in response to the i-th write scan signal GWi. Accordingly, the initialization voltage Vint is applied to the anode of the light-emitting element ED during the initialization period Ti.

During the initialization period Ti, the first emission control transistor ET1 is turned on in response to the i-th emission control signal EMi. Accordingly, the initialization voltage Vint is delivered to the second node N2 through the first emission control transistor ET1 turned on. That is, during the initialization period Ti, the anode of the light-emitting element ED and the second node N2 may be initialized with the initialization voltage Vint.

When the potential “Vs” of the second node N2 changes to the initialization voltage Vint, a change amount “ΔV” of the second node N2 may be “Vref−Vint.”

Here, the first node N1 is coupled to the second node N2 by the storage capacitor Cst, and thus the potential “Vg” of the first node N1 may change depending on a change amount (ΔV=Vref−Vint) of the second node N2. That is, during the initialization period Ti, the potential “Vg” of the first node N1 changes to “Vd−Vref+Vint.” Accordingly, during the initialization period Ti, the gate-source voltage “Vgs” of the first transistor T1 may be “(Vd−Vref+Vint)−Vint=Vd−Vref.” That is, even though the data write period Tw is changed to the initialization period Ti, and thus the potential “Vs” of the second node N2 is changed, the gate-source voltage “Vgs” of the first transistor T1 may be maintained as “Vd−Vref.”

Moreover, regardless of the voltage level of the initialization voltage Vint, the gate-source voltage “Vgs” of the first transistor T1 may be maintained as “Vd−Vref.”

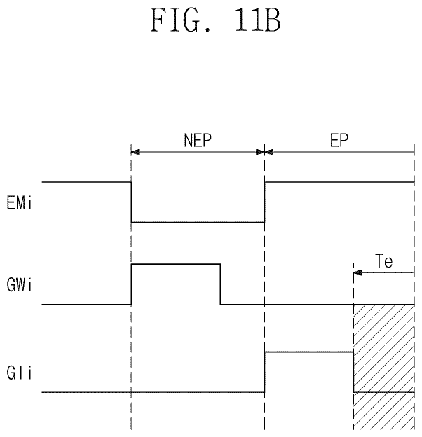

FIGS. 11A and 11B are drawings for describing an operation of a pixel during the emission period Te, according to one or more embodiments of the present disclosure.

Referring to FIGS. 11A and 11B, when the initialization period Ti (see FIG. 10B) is terminated, the emission period Te may occur. As an example of the present disclosure, the emission period Te may overlap the active period EP of the i-th emission control signal EMi.

When the gate-source voltage “Vgs” of the first transistor T1 is greater than the threshold voltage “Vth,” the first transistor T1 may be turned on, and driving current may flow between the first power line VL1 and the second power line VL2 through the turned-on first transistor T1 and the first emission control transistor ET1. The luminance of the light output through the light-emitting element ED may vary depending on the magnitude of the driving current.

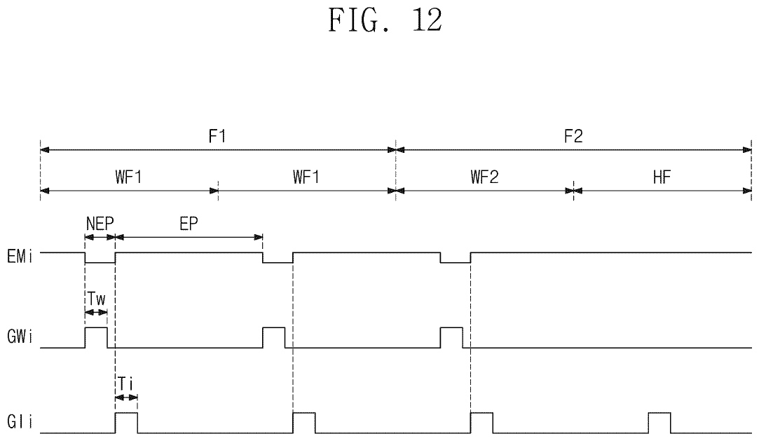

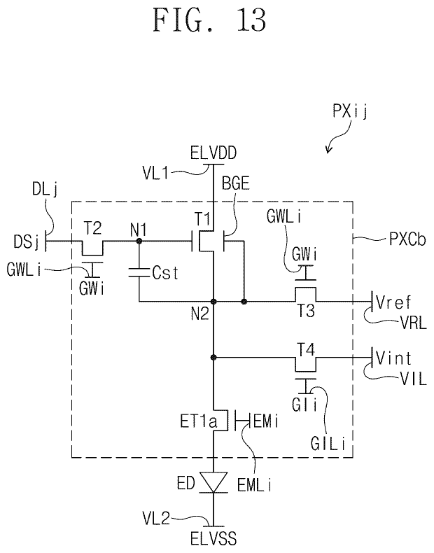

FIG. 12 is a waveform diagram showing an i-th write scan signal, an i-th initialization scan signal, and an i-th emission control signal in a variable frequency mode, according to one or more embodiments of the present disclosure.

Referring to FIGS. 8 and 12, the i-th write scan signal GWi, the i-th initialization scan signal GIi and the i-th emission control signal EMi may be activated during first and second write frames WF1 and WF2. The i-th write scan signal GWi may be deactivated during the holding frame HF. The i-th initialization scan signal GIi may be activated during the holding frame HF. Accordingly, the holding frame HF may not include, or may omit, the data write period Tw, although the holding frame HF may include the initialization period Ti. Moreover, during the holding frame HF, the i-th emission control signal EMi may remain activated without being deactivated. Accordingly, during the holding frame HF, the first emission control transistor ET1 is maintained in a turn-on state. During the initialization period Ti, the second node N2 of the pixel may be initialized with the initialization voltage Vint applied through the fourth transistor T4 and the first emission control transistor ET1. Even when the potential Vs of the second node N2 changes to the initialization voltage Vint during the initialization period Ti of the holding frame HF, the gate-source voltage “Vgs” of the first transistor T1 may be maintained as “Vd−Vref.”

FIG. 13 is a circuit diagram of a pixel, according to one or more embodiments of the present disclosure.

Referring to FIG. 13, the pixel PXij may include a pixel circuit PXCb (or a pixel circuit unit) and the light-emitting element ED electrically connected to the pixel circuit PXCb. In one or more embodiments, the pixel circuit PXCb may include five transistors (referred to as the first to fourth transistors T1 to T4 and a first emission control transistor ET1a) and one capacitor (hereinafter, referred to as the “storage capacitor Cst”). The first to fourth transistors T1 to T4 and the storage capacitor Cst are the same as the configuration shown in FIG. 2, and thus a detailed description is omitted.

The first emission control transistor ET1a is connected between the second node N2 and the light-emitting element ED to receive the i-th emission control signal EMi. The first emission control transistor ET1a may include a first electrode connected to the second node N2, a second electrode connected to the anode of the light-emitting element ED, and a gate electrode connected to the i-th emission control line EMLi. The first emission control transistor ET1a electrically connects or disconnects the second node N2 to or from the anode in response to the i-th emission control signal EMi received through the i-th emission control line EMLi.

The second node N2 may be defined as a node to which the second electrode of the first transistor T1, the second electrode of the storage capacitor Cst, the second electrode of the third transistor T3, the second electrode of the fourth transistor T4, and the first electrode of the first emission control transistor ET1a are connected.

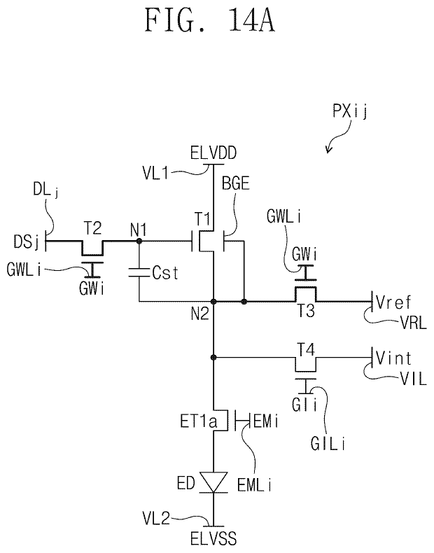

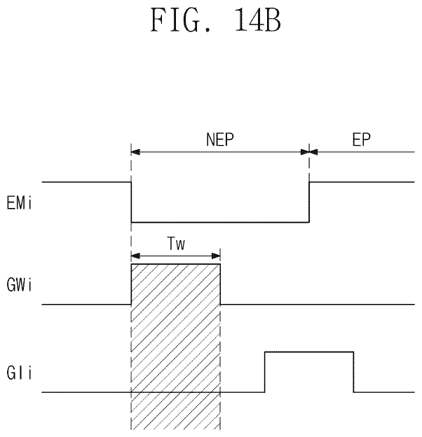

FIGS. 14A and 14B are drawings for describing an operation of a pixel during the data write period Tw, according to one or more embodiments of the present disclosure.

Referring to FIGS. 14A and 14B, the i-th emission control signal EMi has an inactive level during the inactive period NEP and an active level during the active period EP. The i-th write scan signal GWi may have an active level (e.g., a high level) during the data write period Tw, and the i-th initialization scan signal GIi may have an inactive level (e.g., a low level) during the data write period Tw. As an example of the present disclosure, the inactive period NEP of the i-th emission control signal EMi may overlap the data write period Tw.

During the data write period Tw, the second transistor T2 and the third transistor T3 are turned on in response to the i-th write scan signal GWi, and the fourth transistor T4 is turned off in response to the i-th initialization scan signal GIi. Accordingly, during the data write period Tw, the j-th data signal DSj supplied from the j-th data line DLj is applied (or written) to the first node N1 through the second transistor T2 that is turned on. In this case, the first node N1 may have a voltage level corresponding to the j-th data signal DSj (e.g., referred to as “data voltage Vd”). Furthermore, during the data write period Tw, the second node N2 is initialized to the reference voltage Vref through the third transistor T3 that is turned on.

During the inactive period NEP, the first emission control transistor ET1a is turned off in response to the i-th emission control signal EMi. Accordingly, during the inactive period NEP, the second node N2 may be electrically separated from the anode of the light-emitting element ED. That is, during the data write period Tw, when the second node N2 is initialized to the reference voltage Vref, the anode of the light-emitting element ED is not initialized.

During the data write period Tw, the gate-source voltage “Vgs” of the first transistor T1 may be “Vd−Vref.”

The data write period Tw may be terminated at a point in time when the i-th write scan signal GWi is inactive.

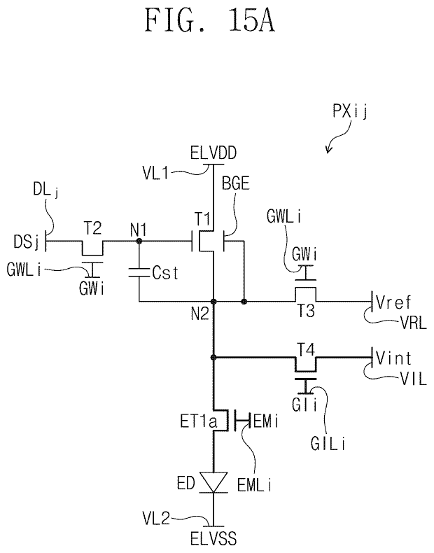

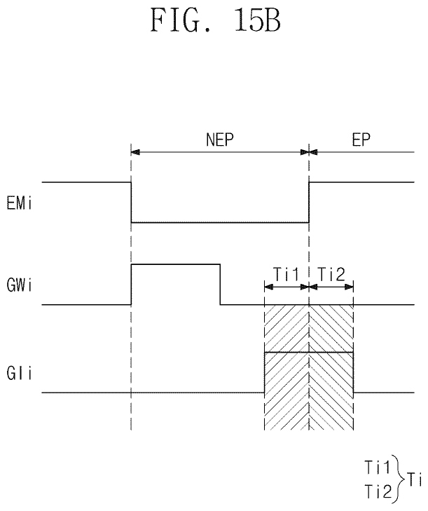

FIGS. 15A and 15B are drawings for describing an operation of a pixel during the initialization period Ti, according to one or more embodiments of the present disclosure.

Referring to FIGS. 15A and 15B, when the data write period Tw (see FIG. 14B) is terminated, the initialization period Ti occurs. That is, the data write period Tw precedes the initialization period Ti. The initialization period Ti may partially overlap the inactive period NEP of the i-th emission control signal EMi. As an example of the present disclosure, the initialization period Ti may include a first initialization period Ti1 and a second initialization period Ti2. The first initialization period Ti1 may overlap the inactive period NEP of the i-th emission control signal EMi. The second initialization period Ti2 may not overlap the inactive period NEP of the i-th emission control signal EMi. That is, the second initialization period Ti2 may overlap the active period EP of the i-th emission control signal EMi.

During the initialization period Ti, the fourth transistor T4 may be turned on in response to the i-th initialization scan signal GIi, and the second and third transistors T2 and T3 may be turned off in response to the i-th write scan signal GWi. Accordingly, the initialization voltage Vint is applied to the second node N2 during the initialization period Ti.

During the first initialization period Ti1, the first emission control transistor ET1a is turned off in response to the i-th emission control signal EMi. Accordingly, during the first initialization period Ti1, the initialization voltage Vint is not transmitted to the anode of the light-emitting element ED through the first emission control transistor ET1a turned off. That is, during the first initialization period Ti1, only the second node N2 may be initialized. Because the first emission control transistor ET1a is turned off during the first initialization period Ti1, the light-emitting element ED may not abnormally emit light even though the initialization voltage Vint has the same voltage level as the second driving voltage ELVSS.

When the potential “Vs” of the second node N2 changes to the initialization voltage Vint, a change amount “ΔV” of the second node N2 may be “Vref−Vint.”

Here, the first node N1 is coupled to the second node N2 by the storage capacitor Cst, and thus the potential “Vg” of the first node N1 may change depending on a change amount “ΔV=Vref−Vint” of the second node N2. That is, during the initialization period Ti, the potential “Vg” of the first node N1 changes to “Vd−Vref+Vint.” Accordingly, during the initialization period Ti, the gate-source voltage “Vgs” of the first transistor T1 may be “(Vd−Vref+Vint)−Vint=Vd−Vref.” That is, even though the potential “Vs” of the second node N2 is changed, the gate-source voltage “Vgs” of the first transistor T1 may be maintained as “Vd−Vref.”

Moreover, regardless of the voltage level of the initialization voltage Vint, the gate-source voltage “Vgs” of the first transistor T1 may be maintained as “Vd−Vref.”

Afterwards, during the second initialization period Ti2, the first emission control transistor ET1a is turned on in response to the i-th emission control signal EMi. Accordingly, during the second initialization period Ti2, the anode of the light-emitting element ED may be initialized with the initialization voltage Vint. As an example of the present disclosure, the duration of the second initialization period Ti2 may be shorter than or equal to the duration of the first initialization period Ti1.

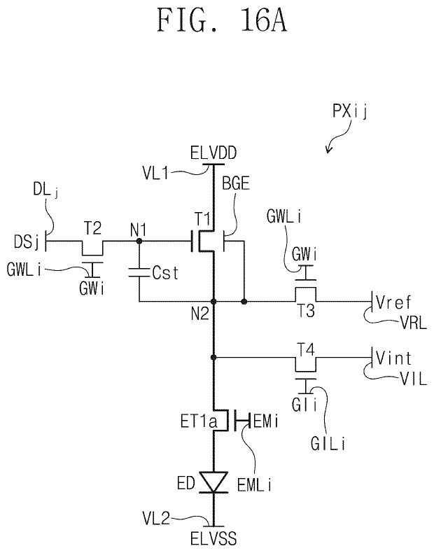

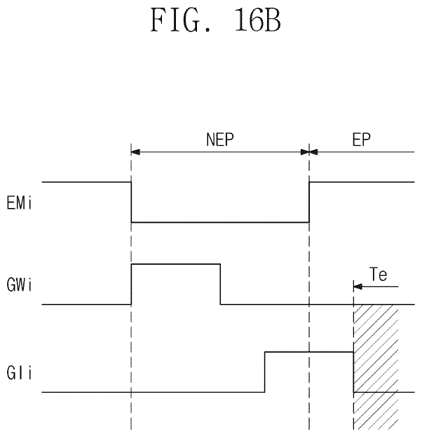

FIGS. 16A and 16B are drawings for describing an operation of a pixel during an emission period, according to one or more embodiments of the present disclosure.

Referring to FIGS. 16A and 16B, when the initialization period Ti (see FIG. 15B) is terminated, the emission period Te may occur. The emission period Te may overlap the active period EP of the i-th emission control signal EMi.

When the gate-source voltage “Vgs” of the first transistor T1 is greater than the threshold voltage “Vth,” the first transistor T1 may be turned on, and driving current may flow between the first power line VL1 and the second power line VL2 through the turned-on first transistor T1 and the first emission control transistor ET1a. The luminance of the light output through the light-emitting element ED may vary depending on the magnitude of the driving current.

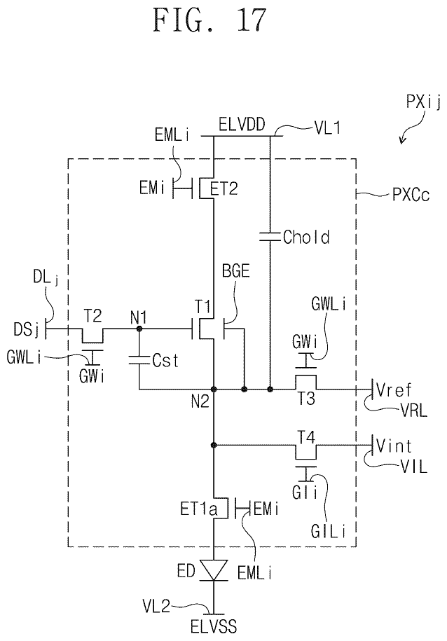

FIG. 17 is a circuit diagram of a pixel, according to one or more embodiments of the present disclosure.

Referring to FIG. 17, the pixel PXij may include a pixel circuit PXCc (or a pixel circuit unit) and the light-emitting element ED electrically connected to the pixel circuit PXCc. In one or more embodiments, the pixel circuit PXCc may include six transistors (referred to as “first to fourth transistors T1 to T4 and first and second emission control transistors ET1a and ET2”), and two capacitors (referred to as the “storage capacitor Cst” and a “hold capacitor Chold”). The first to fourth transistors T1 to T4, the first emission control transistor ET1a, and the storage capacitor Cst are the same as the configuration shown in FIG. 13, and thus a detailed description is omitted.

The second emission control transistor ET2 is connected between the first power line VL1 and the first transistor T1 to receive the i-th emission control signal EMi. The second emission control transistor ET2 may include a first electrode connected to the first power line VL1, a second electrode connected to the first electrode of the first transistor T1, and a gate electrode connected to the i-th emission control line EMLi. The second emission control transistor ET2 electrically connects or disconnects the first power line VL1 to or from the first transistor T1 in response to the i-th emission control signal EMi received through the i-th emission control line EMLi.

The second emission control transistor ET2 is turned off during the inactive period NEP of the i-th emission control signal EMi, and is turned on during the active period EP of the i-th emission control signal EMi. That is, the second emission control transistor ET2 may be turned off during the data write period Tw (see FIG. 14B) and the first initialization period Ti1 (see FIG. 15B), and turned on during the second initialization period Ti2 (see FIG. 15B) and the emission period Te (see FIG. 16B).

The hold capacitor Chold may be connected between the first power line VL1 and the second node N2. The hold capacitor Chold may include a first electrode connected to the first power line VL1 and a second electrode connected to the second node N2. The hold capacitor Chold may store difference voltage between the first power line VL1 and the second node N2. Here, the potential “Vs” of the second node N2 may vary depending on the ratio of the hold capacitor Chold and the storage capacitor Cst.

FIG. 17 illustrates one or more embodiments in which the second emission control transistor ET2 receives the same signal as the i-th emission control signal EMi and is turned on concurrently or substantially simultaneously with the first emission control transistor, but the present disclosure is not limited thereto. Alternatively, the second emission control transistor ET2 may receive an emission control signal (also referred to as a “second emission control signal”) different from the i-th emission control signal EMi.

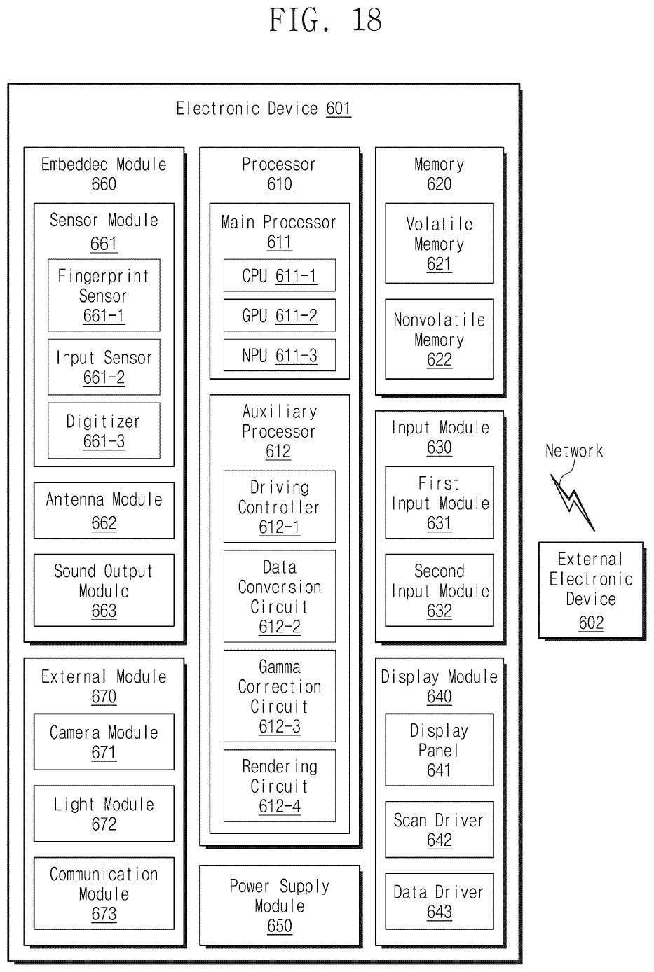

FIG. 18 is a block diagram of an electronic apparatus, according to one or more embodiments of the present disclosure.

Referring to FIG. 18, an electronic apparatus 601 outputs various pieces of information through a display module 640 within an operating system. When a processor 610 executes an application stored in a memory 620, the display module 640 provides application information to a user through a display panel 641.

The processor 610 obtains an external input through an input module 630 or a sensor module 661 and executes an application corresponding to the external input. For example, when the user selects a camera icon displayed on the display panel 641, the processor 610 obtains a user input through an input sensor 661-2 and activates a camera module 671. The processor 610 delivers image data corresponding to a captured image obtained through the camera module 671 to the display module 640. The display module 640 may display an image corresponding to the captured image through the display panel 641.

For another example, when personal information is authenticated on the display module 640, a fingerprint sensor 661-1 obtains entered fingerprint information as input data. The processor 610 compares input data obtained through the fingerprint sensor 661-1 with authentication data stored in the memory 620 and executes an application based on the comparison result. The display module 640 may display information, which is executed depending on the logic of the application, through the display panel 641.

For another example, when a music streaming icon displayed on the display module 640 is selected, the processor 610 obtains a user input through the input sensor 661-2 and activates the music streaming application stored in the memory 620. When a music play command is input by the music streaming application, the processor 610 provides sound information corresponding to the music play command to the user by activating a sound output module 663.

The operation of the electronic apparatus 601 has been briefly described above. Hereinafter, a configuration of the electronic apparatus 601 will be described in detail. Some of components of the electronic apparatus 601, which will be described below, may be integrated and provided as one configuration, or the one configuration may be provided to be separated into two or more configurations.

Referring to FIG. 18, the electronic apparatus 601 may communicate with an external electronic apparatus 602 through a network (e.g., a short-range wireless communication network or a long-range wireless communication network). According to one or more embodiments, the electronic apparatus 601 may include the processor 610, the memory 620, the input module 630, the display module 640, a power supply module 650, an embedded module 660, and an external module 670. According to one or more embodiments, in the electronic apparatus 601, at least one of the above-described components may be omitted, or one or more other components may be added. According to one or more embodiments, some (e.g., the sensor module 661, an antenna module 662, or the sound output module 663) of the components described above may be integrated into another component (e.g., the display module 640).

The processor 610 may execute software to control at least another component (e.g., hardware or software component) of the electronic apparatus 601 connected to the processor 610, and may process and calculate various types of data. According to one or more embodiments, as at least part of data processing or calculation, the processor 610 may store instructions or data received from other components (e.g., the input module 630, the sensor module 661 or a communication module 673) into a volatile memory 621, may process instructions or data stored in the volatile memory 621. The result data may be stored in a nonvolatile memory 622.

The processor 610 may include a main processor 611 and an auxiliary processor 612. The main processor 611 may include one or more of a central processing unit (CPU) 611-1 or an application processor (AP). The main processor 611 may further include one or more of a graphic processing unit (GPU) 611-2, a communication processor (CP), and an image signal processor (ISP). The main processor 611 may further include a neural processing unit (NPU) 611-3. The NPU 611-3 may be a processor that is specialized in processing an artificial intelligence model. The artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the networks, but may not be limited to the above-described example. In addition to a hardware structure, additionally or alternatively, the artificial intelligence model may include a software structure. At least two of the processing units and the processors that are described above may be implemented as one integrated component (e.g., a single chip) or may be implemented as independent components (e.g., a plurality of chips).

The auxiliary processor 612 may include a driving controller 612-1. The driving controller 612-1 may include an interface converting circuit and a timing control circuit. The driving controller 612-1 receives an image signal from the main processor 611, converts the data format of the image signal so as to be suitable for the interface specifications with the display module 640, and outputs image data. The driving controller 612-1 may output various control signals suitable to drive the display module 640. The configuration of the driving controller 612-1 is substantially similar to the driving controller 100 shown in FIG. 1, and thus detailed descriptions are omitted to avoid redundancy.

The auxiliary processor 612 may further include a data-converting circuit 612-2, a gamma-correcting circuit 612-3, and a rendering circuit 612-4. The data-converting circuit 612-2 may receive the image data from the driving controller 612-1, and may compensates for the image data such that an image is displayed at a desired luminance according to characteristics of the electronic apparatus 601 or setting of the user or may convert the image data to reduce power consumption or compensate for afterimages. The gamma-correcting circuit 612-3 may convert the image data, a gamma reference voltage, or the like such that the image displayed on the electronic apparatus 601 has desired gamma characteristics. The rendering circuit 612-4 may receive the image data from the driving controller 612-1 and may render the image data in consideration of a pixel arrangement of the display panel 641 applied to the electronic apparatus 601. At least one of the data-converting circuit 612-2, the gamma-correcting circuit 612-3, and the rendering circuit 612-4 may be integrated into another component (e.g., the main processor 611 or the driving controller 612-1). At least one of the data-converting circuit 612-2, the gamma-correcting circuit 612-3, and the rendering circuit 612-4 may be integrated into a data driver 643 to be described below.

The memory 620 may store various pieces of data, which are used by at least one component (e.g., the processor 610 or the sensor module 661) of the electronic apparatus 601 and input data or output data for commands related thereto. The memory 620 may include at least one or more of the volatile memory 621 and the nonvolatile memory 622.

The input module 630 may receive, from the outside (e.g., the user or the external electronic apparatus 602) of the electronic apparatus 601, commands or data to be used in a components (e.g., the processor 610, the sensor module 661, or the sound output module 663) of the electronic apparatus 601.

The input module 630 may include a first input module 631, through which the commands or data are input from the user, and a second input module 632 through which the commands or data are input from the external electronic apparatus 602. The first input module 631 may include a microphone, a mouse, a keyboard, a key (e.g., a button), or a pen (e.g., a passive pen or an active pen). The second input module 632 may support a designated protocol capable of being connected to the external electronic apparatus 602 by wire or wirelessly. According to one or more embodiments, the second input module 632 may include a high definition multimedia interface (HDMI), a universal serial bus (USB) interface, a secure digital (SD) card interface, or an audio interface. The second input module 632 may include a connector that may be physically connected to the external electronic apparatus 602, for example, an HDMI connector, a USB connector, an SD card connector, or an audio connector (e.g., a headphone connector).

The display module 640 provides visual information to the user. The display module 640 may include the display panel 641, a scan driver 642, and the data driver 643. The display module 640 may further include a window, a chassis, a bracket, or the like for protecting the display panel 641. The display module 640 may further include a light-emitting driver, a voltage generator, and the like. The voltage generator may output various voltages (e.g., the first and second driving voltages ELVDD and ELVSS (see FIG. 1)) suitable to drive the display panel 641. The configuration of the display panel 641, the scan driver 642, the data driver 643, and the voltage generator is substantially similar to the configuration of the display panel DP, the scan-driving circuit 300, the data-driving circuit 200, and the voltage generator 400 shown in FIG. 1, and thus detailed descriptions are omitted to avoid redundancy.

The power supply module 650 supplies power to the components of the electronic apparatus 601. The power supply module 650 may include a battery that charges a power voltage. The battery may include a non-rechargeable primary cell, a rechargeable secondary cell, a fuel cell, or the like. The power supply module 650 may include a power management integrated circuit (PMIC). The PMIC supplies optimized power to the above-described modules and modules which will be described below. The power supply module 650 may include a wireless power transmission/reception member electrically connected to the battery. The wireless power transmission/reception member may include a plurality of coil-shaped antenna radiators.

The electronic apparatus 601 may further include the embedded module 660 and the external module 670. The embedded module 660 may include the sensor module 661, the antenna module 662, and the sound output module 663. The external module 670 may include the camera module 671, a light module 672, and the communication module 673.

The sensor module 661 may detect an input from the user's body or an input from a pen among the first input module 631, and may generate an electrical signal or data value corresponding to the input. The sensor module 661 may include at least one of the fingerprint sensor 661-1, the input sensor 661-2, and a digitizer 661-3.

The fingerprint sensor 661-1 may generate a data value corresponding to a fingerprint of the user. The fingerprint sensor 661-1 may include one of an optical-type fingerprint sensor or a capacitance-type fingerprint sensor.

The input sensor 661-2 may generate a data value corresponding to coordinate information of an input by a body of the user or an input by a pen. The input sensor 661-2 generates the change in capacitance due to the input as the data value. The input sensor 661-2 may sense an input by a passive pen or may transmit or receive data to or from an active pen.

The input sensor 661-2 may also measure a biometric signal, such as blood pressure, moisture, or body fat. For example, when the user touches a part of the body to a sensor layer or sensing panel and does not move during a specific period, the input sensor 661-2 may detect the biometric signal and may output information desired by the user to the display module 640 based on a changes in electric fields caused by the part of the body.

The digitizer 661-3 may generate the data value corresponding to coordinate information of an input by the pen. The digitizer 661-3 generates an electromagnetic change amount due to the input as the data value. The digitizer 661-3 may sense input by the passive pen or transmit or receive data to or from the active pen.

At least one of the fingerprint sensor 661-1, the input sensor 661-2, and the digitizer 661-3 may be implemented as a sensor layer formed on the display panel 641 through a subsequent process. The fingerprint sensor 661-1, the input sensor 661-2, and the digitizer 661-3 may be placed on the upper side of the display panel 641, and one (e.g., the digitizer 661-3) of the fingerprint sensor 661-1, the input sensor 661-2, and the digitizer 661-3 may be placed on the lower side of the display panel 641.

At least two or more of the fingerprint sensor 661-1, the input sensor 661-2, and the digitizer 661-3 may be formed to be integrated into one sensing panel through the same process. When being integrated into one sensing panel, the sensing panel may be placed between the display panel 641 and a window placed on the upper side of the display panel 641. According to one or more embodiments, the sensing panel may be placed on a window, and the location of the sensing panel is not particularly limited thereto.

At least one of the fingerprint sensor 661-1, the input sensor 661-2, and the digitizer 661-3 may be built into the display panel 641. That is, at least one of the fingerprint sensor 661-1, the input sensor 661-2, and the digitizer 661-3 may be concurrently or substantially simultaneously formed through a process of forming elements (e.g., a light-emitting element, a transistor, or the like) included in the display panel 641.

Besides, the sensor module 661 may generate an electrical signal or a data value corresponding to the internal state or external state of the electronic apparatus 601. For example, the sensor module 661 may further include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illumination sensor.

The antenna module 662 may include one or more antennas to transmit or receive the signal or power to or from an external source. According to one or more embodiments, the communication module 673 may transmit or receive the signal to or from the external electronic apparatus 602 through the antenna suitable for a communication method. An antenna pattern of the antenna module 662 may be integrated into the input sensor 661-2 or one component (e.g., the display panel 641) of the display module 640.

The sound output module 663 may be a device for outputting an audio signal to the outside of the electronic apparatus 601 and, for example, may include a speaker used for general purposes, such as multimedia playback or recording playback, and a receiver used only for receiving a call. According to one or more embodiments, the receiver may be implemented separately from the speaker or may be integrated with the speaker. A sound output pattern of the sound output module 663 may be integrated into the display module 640.

The camera module 671 may shoot a still image or a video image. According to one or more embodiments, the camera module 671 may include one or more lenses, an image sensor, or an image signal processor. The camera module 671 may further include an infrared camera capable of measuring the presence or absence of the user, a position of the user, a gaze of the user, or the like.

The light module 672 may provide light. The light module 672 may include a light-emitting diode or a xenon lamp. The light module 672 may operate in conjunction with the camera module 671 or may operate independently from the camera module 671.

The communication module 673 may support establishing a wired or wireless communication channel between the electronic apparatus 601 and the external electronic apparatus 602 and performing communication through the established communication channel. The communication module 673 may include one or all of wireless communication modules, such as a cellular communication module, a short-range wireless communication module, or a global navigation satellite system (GNSS) communication module, or wired communication modules, such as a local area network (LAN) communication module or a power line communication module. The communication module 673 may communicate with the external electronic apparatus 602 through a short-range communication network, such as Bluetooth®, (Bluetooth® being a registered trademark of Bluetooth Sig, Inc., Kirkland, WA), WiFi® direct (Wi-Fi® being a registered trademark of the non-profit Wi-Fi Alliance), or infrared data association (IrDA) or a long-range communication network, such as a cellular network, Internet, or a computer network (e.g., the LAN or a wide area network (WAN)). The above-mentioned various communication modules 673 may be implemented into one chip or may be respectively implemented into separate chips.

The input module 630, the sensor module 661, the camera module 671, and the like may be utilized to control an operation of the display module 640 in conjunction with the processor 610.

The processor 610 outputs commands or data to the display module 640, the sound output module 663, the camera module 671, or the light module 672 based on input data received from the input module 630. For example, the processor 610 may generate image data in response to input data applied through a mouse, an active pen, or the like to output the generated image data to the display module 640 or may generate command data in response to the input data to output the generated command data to the camera module 671 or the light module 672. When no input data is received from the input module 630 during a specific period, the processor 610 may switch an operation mode of the electronic apparatus 601 to a low-power mode or a sleep mode to reduce power consumed in the electronic apparatus 601.

The processor 610 outputs commands or data to the display module 640, the sound output module 663, the camera module 671, or the light module 672 based on sensing data received from the sensor module 661. For example, the processor 610 may compare authentication data authorized by the fingerprint sensor 661-1 with the authentication data stored in the memory 620, and then may execute an application depending on the comparison result. The processor 610 may execute commands or may output corresponding image data to the display module 640 based on sensing data sensed by the input sensor 661-2 or the digitizer 661-3. When the sensor module 661 includes a temperature sensor, the processor 610 receives temperature data regarding the measured temperature from the sensor module 661, and may further perform luminance correction on image data based on the temperature data.

The processor 610 may receive measurement data regarding the presence or absence of the user, the user's location, and the user's gaze from the camera module 671. The processor 610 may further perform luminance correction on the image data based on the measurement data. For example, the processor 610 that determines the presence or absence of the user through an input from the camera module 671 may output image data, of which the luminance is corrected through the data-converting circuit 612-2 or the gamma-correcting circuit 612-3, to the display module 640.

Some of the components may be connected to each other through communication methods between peripheral devices, for example, a bus, a general purpose input/output (GPIO), a serial peripheral interface (SPI), a mobile industry processor interface (MIPI), or an ultra-path interconnect (UPI) link and may exchange a signal (e.g., commands or data) between each other. The processor 610 may communicate with the display module 640 through a mutually promised interface, and for example, may use any one of the above-described communication methods, and the present disclosure is not limited to the above-described communication methods.

The electronic apparatus 601 according to various embodiments disclosed in the specification may be implemented with various types of devices. The electronic apparatus 601 may include, for example, at least one of a portable communication device (e.g., a smart phone), a computer device, a portable multimedia device, a portable medical device, a camera, a wearable device, or a home appliance. The electronic apparatus 601 according to one or more embodiments of this specification may not be limited to the above-described devices.

Although one or more embodiments of the present disclosure has been described for illustrative purposes, those skilled in the art will appreciate that various modifications, and substitutions are possible, without departing from the scope and spirit of the present disclosure as disclosed in the accompanying claims.

Accordingly, the technical scope of the present disclosure is not limited to the detailed description of this specification, but should be defined by the claims.

According to one or more embodiments of the present disclosure, the number of transistors and capacitors, which constitute a pixel, may be reduced, thereby simplifying a circuit configuration.

Moreover, it is possible to reduce or prevent the likelihood of a problem of not accurately expressing black gradation because current leaks through a driving transistor even when data voltage for expressing the black gradation does not have negative voltage. As a result, the overall display quality may be improved.

While the present disclosure has been described with reference to embodiments thereof, it will be apparent to those of ordinary skill in the art that various changes and modifications may be made thereto without departing from the spirit and scope of the present disclosure as set forth in the following claims, with functional equivalents thereof to be included therein.

What is claimed is:

1. A display device comprising:
a display panel comprising a pixel, the pixel comprising:
a light-emitting element comprising an anode and a cathode;
a first transistor connected between a first power line and the anode, and configured to operate according to a potential of a first node;
a second transistor connected between the first node and a data line, and configured to receive a first scan signal;
a third transistor connected between a second node and a reference voltage line, and configured to receive the first scan signal;
a fourth transistor connected between the second node and an initialization voltage line, and configured to receive a second scan signal; and
a storage capacitor connected between the first node and the second node.

2. The display device of claim 1, wherein, during a data write period, the first scan signal is configured to have an active level, and the second scan signal is configured to have an inactive level, and
wherein, during an initialization period following the data write period, the first scan signal is configured to have the inactive level, and the second scan signal is configured to have the active level.

3. The display device of claim 2, wherein, during the data write period, the first node is configured to receive a data voltage, and the second node is configured to be initialized with a reference voltage from the reference voltage line.

4. The display device of claim 2, wherein, during the initialization period, the second node is configured to be initialized with an initialization voltage from the initialization voltage line, and
wherein a gate-source voltage of the first transistor during the initialization period is configured to be equal to the gate-source voltage of the first transistor during the data write period.

5. The display device of claim 2, wherein the cathode of the light-emitting element is connected to a second power line configured to receive a second driving voltage, and
wherein the reference voltage line is configured to receive a reference voltage having a higher voltage level than that of the second driving voltage.

6. The display device of claim 5, wherein the initialization voltage line is configured to receive an initialization voltage having a voltage level that is lower than or equal to that of the second driving voltage.

7. The display device of claim 2, wherein the pixel further comprises a first emission control transistor connected between the second node and the anode, and configured to receive a first emission control signal.

8. The display device of claim 7, wherein the first emission control signal is configured to have the inactive level during an inactive period, and is configured to have the active level during an active period,
wherein the inactive period overlaps the data write period, and
wherein the initialization period comprises a first initialization period overlapping the inactive period, and a second initialization period overlapping the active period.

9. The display device of claim 8, wherein, during the data write period, the first node is configured to receive a data voltage, and the second node is configured to be initialized with a reference voltage from the reference voltage line.

10. The display device of claim 8, wherein, during the initialization period, the second node is configured to be initialized with an initialization voltage from the initialization voltage line, and
wherein a gate-source voltage of the first transistor during the initialization period is configured to be equal to the gate-source voltage of the first transistor during the data write period.

11. The display device of claim 7, wherein the pixel further comprises:
a second emission control transistor connected between the first power line and the first transistor, and configured to receive a second emission control signal; and
a hold capacitor connected between the second node and the first power line.

12. The display device of claim 2, wherein the display panel is configured to display an image during driving frames comprising a write frame and at least one holding frame,
wherein the write frame comprises the data write period and the initialization period, and
wherein the holding frame does not comprise the data write period, and comprises the initialization period.

13. The display device of claim 1, wherein the first transistor, the second transistor, the third transistor, and the fourth transistor comprise an oxide semiconductor.

14. A display device comprising:
a display panel comprising a pixel, the pixel comprising:
a light-emitting element comprising an anode and a cathode;
a first transistor connected between a first power line and the anode, and configured to operate according to a potential of a first node;
a second transistor connected between the first node and a data line, and configured to receive a first scan signal;
a third transistor connected between a second node and a reference voltage line, and configured to receive the first scan signal;
an emission control transistor connected between the second node and the anode, and configured to receive an emission control signal;
a fourth transistor connected between the anode and an initialization voltage line, and configured to receive a second scan signal; and
a storage capacitor connected between the first node and the second node.

15. The display device of claim 14, wherein, during a data write period, the first scan signal is configured to have an active level, and the second scan signal is configured to have an inactive level, and
wherein, during an initialization period following the data write period, the first scan signal is configured to have the inactive level, and the second scan signal is configured to have the active level.

16. The display device of claim 15, wherein the emission control signal is configured to have the inactive level during an inactive period, and is configured to have the active level during an active period, and
wherein the inactive period overlaps the data write period and does not overlap the initialization period.

17. The display device of claim 16, wherein, during the data write period, the first node is configured to receive a data voltage, and the second node is configured to be initialized with a reference voltage from the reference voltage line.

18. The display device of claim 16, wherein, during the initialization period, the second node is configured to be initialized with an initialization voltage from the initialization voltage line, and
wherein a gate-source voltage of the first transistor during the initialization period is configured to be equal to the gate-source voltage of the first transistor during the data write period.

19. The display device of claim 15, wherein the display panel is configured to display an image during driving frames comprising a write frame and at least one holding frame,
wherein the write frame comprises the data write period and the initialization period, and
wherein the holding frame does not comprise the data write period, and comprises the initialization period.

20. An electronic apparatus comprising:
a display module comprising a pixel; and
a processor configured to drive the display module,
wherein the pixel comprises:
a light-emitting element comprising an anode and a cathode;
a first transistor connected between a first power line and the anode, and configured to operate according to a potential of a first node;
a second transistor connected between the first node and a data line, and configured to receive a first scan signal;
a third transistor connected between a second node and a reference voltage line, and configured to receive the first scan signal;
a fourth transistor connected between the second node and an initialization voltage line, and configured to receive a second scan signal; and
a storage capacitor connected between the first node and the second node.
